(19) United States
(12) Patent Application Publication
(10) Pub. No.: US 2012/0045729 A1
(43) Pub. Date: Feb. 23, 2012

(54) Illuminated orthodontic retainer and case therefor

(76) Inventors: Wanda Ortiz, Westbury, NY (US); Myrna Ortiz, Westbury, NY (US)

(21) Appl. No.: 13/137,426

(22) Filed: Aug. 15, 2011

Related U.S. Application Data
(63) Continuation-in-part of application No. 12/007,506, filed on Jan. 11, 2008, now Pat. No. 7,997,898.

(51) Int. Cl. A61C 7/08

(52) U.S. Cl. 433/6

(57) ABSTRACT

A standard orthodontic retainer is modified on its surface opposite the palate and facing the patient's tongue with a light, a small battery to provide power for the light means, and a frame beneath the light that allows a template to be removably slid into the frame. The template consists of a design such as a heart, a letter of the alphabet, a symbol, or other design that, when the light is activated, shines the pattern onto the top of the tongue of the user. The template can be made so that the design displayed on the user's tongue is of any desired color or color combination. Alternatively, the color of the displayed design may be created by the color of the light or by an additional template consisting of an optical filter providing the desired color. A case for the retainer is provided. The case or retainer is provided with an indicator to allow the user to locate the retainer.

This application is a Continuation-in-Part of application Ser. No. 12/007,506, filed Jan. 11, 2008, and which will mature into U.S. Pat. No. 7,997,898, on Aug. 16, 2011. The present invention relates to an illuminated orthodontic retainer and case therefor. The inventive retainer is intended to illuminate a portion of the tongue of the user for aesthetic purposes. The case is intended to releasably enclose the retainer to provide storage. The subject invention includes remotely actuated indicators to allow the user to easily find the retainer and case. In the prior art, orthodontic retainers are well known and are used for the purpose of facilitating straightening of the user's teeth and aligning their bite. For this purpose, such retainers have a palatal vault portion typically custom made of a soft plastic material that underlies the palate of the user and has wiring surrounding the palatal vault and specifically designed to engage specified teeth so that when the retainer is worn, the specified teeth are straightened so that the user's bite is corrected.

### BACKGROUND OF THE INVENTION

Heretofore, orthodontic retainers have been limited in their construction to merely facilitating correction of the user's bite. With the advent of tattoos and the use of illumination means on clothing including hats and shirts, there has evolved a desire on the part of the consuming public to use the human body as a “canvas” on which artistic designs are displayed. Within the mouth, grilles are sometimes designed to fit over the teeth for aesthetic reasons. Additionally, sometimes teeth are capped with aesthetic designs including the use of precious stones and other features. Many of these aesthetic products such as tooth caps, tattoos, and others are either irreversible or expensive and/or difficult to reverse. As such, if an invention could be devised permitting marking of the body for aesthetic reasons, but in which the marking is not permanent, such an invention would be attractive to the consuming public. It is with this thought in mind that the present invention was developed.

People often misplace items. This is true of retainers and their cases. If it were possible to devise a retainer and its case incorporating audible and visual indicators that could be remotely actuated so that the user could easily find them when needed, it would be advantageous.

The following prior art is known to Applicants:

U.S. Pat. No. 6,089,864 to Buckner et al. discloses a bio-feedback data acquisition tooth guard and the method of its manufacture and use. This device is designed to evaluate, detect and treat people who suffer from the chronic grinding of teeth known as “bruxing.” The apparatus includes a pressure sensor contained therein and electronics for detecting activation of a sensor due to bruxing.

U.S. Pat. No. 6,499,995 to Schwartz discloses a phosphorescent dental appliance that is made of a material permitting it to glow in the dark. The Schwartz device is activated through shining of light thereon and is made of a phosphorescent material. The device of Schwartz does not contemplate the illumination means and pattern that are disclosed in the present invention.

U.S. Pat. No. 6,702,575 to Hilliard discloses a method and apparatus for orthodontic treatment that includes a removable orthodontic aligner. The Hilliard device contemplates the addition of auxiliary devices removably attachable thereto which include ornamental or decorative designs. Hilliard fails to teach or suggest the illumination means contemplated in the present invention.

U.S. Pat. No. 6,837,606 to Baillie-Hamilton discloses light emitting device and arrays thereof. Baillie-Hamilton fails to contemplate the use of illumination means in the environment contemplated in the present invention.

### SUMMARY OF THE INVENTION

The present invention relates to an illuminated orthodontic retainer and case therefor. The present invention includes the following interrelated objects, aspects and features:

(1) In a first aspect, the present invention contemplates modifications to an orthodontic retainer as commonly used by orthodontists in facilitating the straightening of a person's teeth and alignment of their bite.

(2) In such an orthodontic retainer, the structures include a maxillary palatal vault made of a material such as soft plastic and molded to closely match the contours of the palate of the patient. About the periphery of the maxillary palatal vault, a plurality of wires are provided in specific locations so that when the retainer is worn, those wires interact with the patient's teeth to cause the teeth to be straightened and the bite to be aligned.

(3) The present invention consists of a modification of the structure of a standard orthodontic retainer. In particular, the present invention is mounted on the undersurface of the maxillary palatal vault, the surface opposite the palate and facing the patient's tongue.

(4) The invention consists of a source of light or illumination means, a source of power comprising a small battery to provide power for the illumination means, and a frame beneath the illumination means that allows pattern means comprising a template to be slid into the frame or removed therefrom.

(5) The template consists of a design such as a heart, a letter of the alphabet, a symbol, or other design that, when the illumination means is activated, shines the pattern onto the top of the tongue of the user.

(6) The template can be made in such a manner that the design displayed on the user's tongue is of any desired color or color combination. Alternatively, the color of the displayed design may be created by the color of the illumination means or by an additional template consisting of an optical translucent filter providing the desired color.

(7) An on-off switch is provided at a suitable location to facilitate activating and deactivating the device.

(8) If desired, the maxillary palatal vault may be made of a thickness allowing the illumination means, the battery and the wiring to be imbedded therewithin, with the light exposed downwardly, and with the frame adjacent the lower surface of the maxillary palatal vault.

(9) Additional advantageous features are provided. The retainer may be provided with a small electrical circuit allowing activation of an audible and/or visual indicator to allow the user to easily find the retainer. Preferably, activation is through a wireless transmitter/receiver combination with the receiver being mounted on the retainer and including a controller to control activation and deactivation of the audible/visual indicators. A wireless transmitter may be incorporated in a key FOB, cellular telephone, or any other desired means.

(10) An additional option is a tubular indicator removably mountable on the wire of the retainer. For this purpose, the tubular indicator has an elongated slot allowing it to be placed over the retainer wire. The tubular indicator has a plurality of small lights such as LEDs mounted thereon and, if desired, an audible indicator such as a horn or beeper. The indicator(s) may be activated in the same manner as described above in paragraph (9).

(11) Additionally, the case for the retainer may have incorporated therein visual/audible indicators to allow the user to easily locate the case and the retainer contained therein. The manner of actuation of the audible/visual indicators on the case is the same as described above with reference to paragraph (9).

As such, it is a first object of the present invention to provide an illuminated orthodontic retainer.

It is a further object of the present invention to provide such a device in which illumination means is imbedded in the maxillary palatal vault of the retainer.

It is a still further object of the present invention to provide such a device in which a battery is also imbedded in the maxillary palatal vault with wiring connecting the battery and illumination means.

It is a still further object of the present invention to provide such a device in which a template is slidably received on the vault.

It is a still further object of the present invention to provide such a device in which the template may easily be removed and replaced with a template bearing another design.

It is a yet further object of the present invention to provide such a device in which an audible/visual indicator is either permanently mounted on the retainer or removably mounted on its wire, or both.

It is a still further object of the present invention to provide such a device in which a case is provided to house the retainer and the case has mounted thereon visual/audible indicators.

It is a still further object of the present invention to provide such a device in which the audible/visual indicators may be remotely actuated using a wireless transmitter/receiver.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a bottom view of the inventive illuminated orthodontic retainer.

FIG. 2 shows a front view of the inventive retainer.

FIG. 3 shows a cross-sectional view along the line 3-3 of FIG. 1.

FIG. 4 shows a cross-sectional view along the line 4-4 of FIG. 1.

FIG. 5 shows a top view of the tongue with an illuminated design visible thereon.

FIG. 6 shows an enlarged bottom view of the vault showing the frame used to removably retain a template under the illumination means.

FIG. 7 shows a top view of the retainer to which is removably attached a slotted tube indicator device.

FIG. 8 shows an enlarged view of the slotted tube indicator device.

FIG. 9 shows a rear view of the retainer with the slotted tube indicator device mounted thereon.

FIG. 10 shows a schematic representation of electrical circuitry used in connection with the present invention.

FIG. 11 shows a front perspective view of the inventive case.

FIG. 12 shows a top view of the case in a first variation in which LED lights are employed.

FIG. 13 shows a variation on the view of FIG. 12 in which LED strips are employed.

FIG. 14 shows a bottom view of the case of FIG. 12.

FIG. 15 shows a bottom view of the case of FIG. 13.

### SPECIFIC DESCRIPTION OF THE PREFERRED EMBODIMENTS

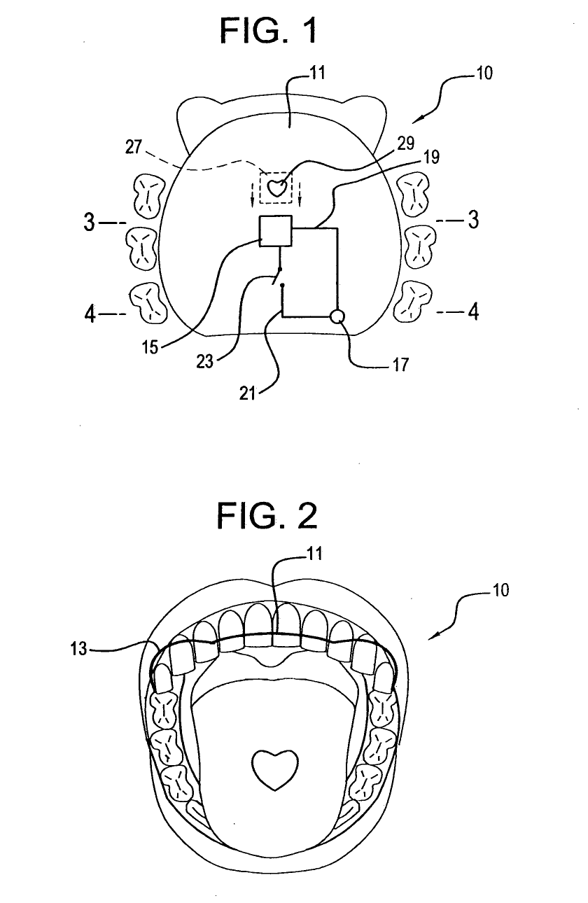

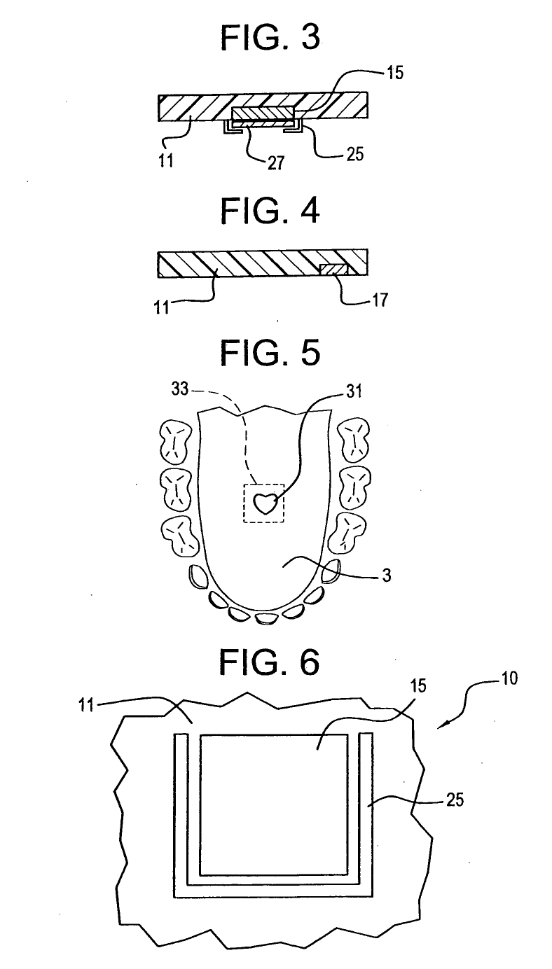

With reference to FIGS. 1-6, the retainer of the present invention is generally designated by the reference numeral 10 and is seen to include a maxillary palatal vault 11 having peripheral wires 13 (FIG. 2) arranged in a manner well known to those of ordinary skill in the art to facilitate straightening of teeth and alignment of the bite. As best seen in FIGS. 1 and 3, the vault 11 has embedded therein illumination means 15 consisting of a light such as a thin light emitting diode (LED) or a plurality of pixels that may be formed by a single lightbulb and a pixelated lens such as commonly seen on a vehicle tail light.

With reference to FIGS. 1 and 4, a battery 17 is also embedded in the vault and electrical wires 19 and 21 complete a circuit between the illumination means 15 and the battery 17. Additionally, a switch 23 is schematically shown in FIG. 1 and may be of any desired design such as a pushbutton switch, a toggle switch, or any other switch that may be miniaturized so that it can be mounted on the vault 11 without irritation to the mouth of the user.

As seen in FIGS. 3 and 6, a frame 25 is located on the vault 11 surrounding three sides of the illumination means 15. As best seen in FIG. 3, the frame 25 comprises an inverted L-shaped cross-section that provides a recess allowing removable receipt of a template 27 (FIGS. 1 and 3). The template may be of any desired material and preferably includes a specially shaped opening such as the heart-shaped opening 29 seen in FIG. 1. Such an opening results in a heart-shaped lighted area 31 displayed on the tongue 3 of the user. FIG. 5 also shows a dotted line 33 that shows the outline of the template 27. The template 27 may be made of any desired material including opaque materials and translucent materials. When the template 27 is made of an opaque material, the light may only shine through an opening within the shape, for example 29 (FIG. 1). In that embodiment, the color of the design 31 displayed on the tongue 3 will correspond to the color of the light emanating from the illumination means 15. That color may easily be determined by providing a light of a desired color or a white light with a translucent filter mounted thereover.

In similar fashion, the template 27 may be made of a translucent material in any desired color. For example, the template could be made of a material that is opaque except for a translucent portion in a desired shape and made in a desired color.

The design that creates the design 31 on the tongue 3 as seen in FIG. 5 may be any desired design, shape and/or color to result in a desired display on the user's tongue.

The battery 17 may be any desired type of battery with smaller and lighter batteries being more desirable. Batteries used for hearing aids and watches are suitable for use in association with the present invention.

If desired, the vault 11 may be made of a material that carries a desirable flavor such as cherry, blueberry, orange, etc. If desired, alternatively, a flavor packet may be attached to the palatal vault 11 of the retainer 10. The frame may be made of any suitable plastic or metal so long as it does not have any sharp edges that could cut the tongue or mouth of the user. As explained above, the illumination means 15 may comprise any miniature light suitable for embedding in the vault 11. Examples of such lights include light emitting diodes (LED) and lights covered by pixelated filters to cause light diffusion and uniformity of display.

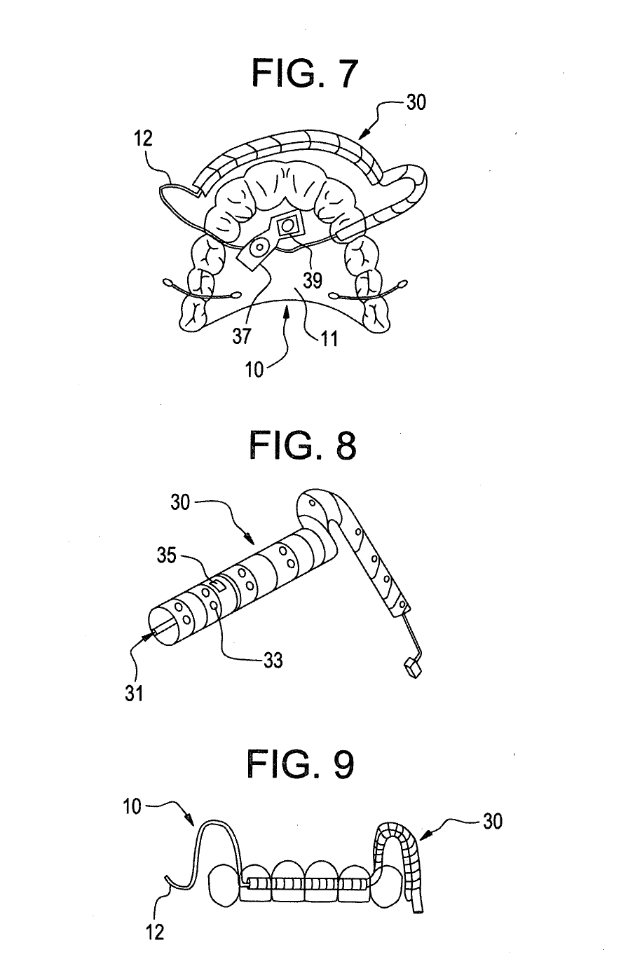

Reference is now made to FIGS. 7-15 which depict additional features of the present invention. With reference first to FIGS. 7-9, a tubular indicator 30 includes a longitudinal slot 31 and a plurality of LED lights 33. An audible indicator 35 such as a beeper, horn or other similar device including a recorded voice programmed on a voice synthesizer chip is also shown mounted on the outer surface of the tubular indicator 30. As shown in FIG. 7, the wire 12 of the retainer 10 receives the tubular indicator 30 by inserting the wire 12 within the interior of the indicator 30 via the slot 31. FIG. 7 also shows an alternative in which an audible indicator 37 and a visual indicator 39 are mounted on the palatal vault 11 of the retainer 10.

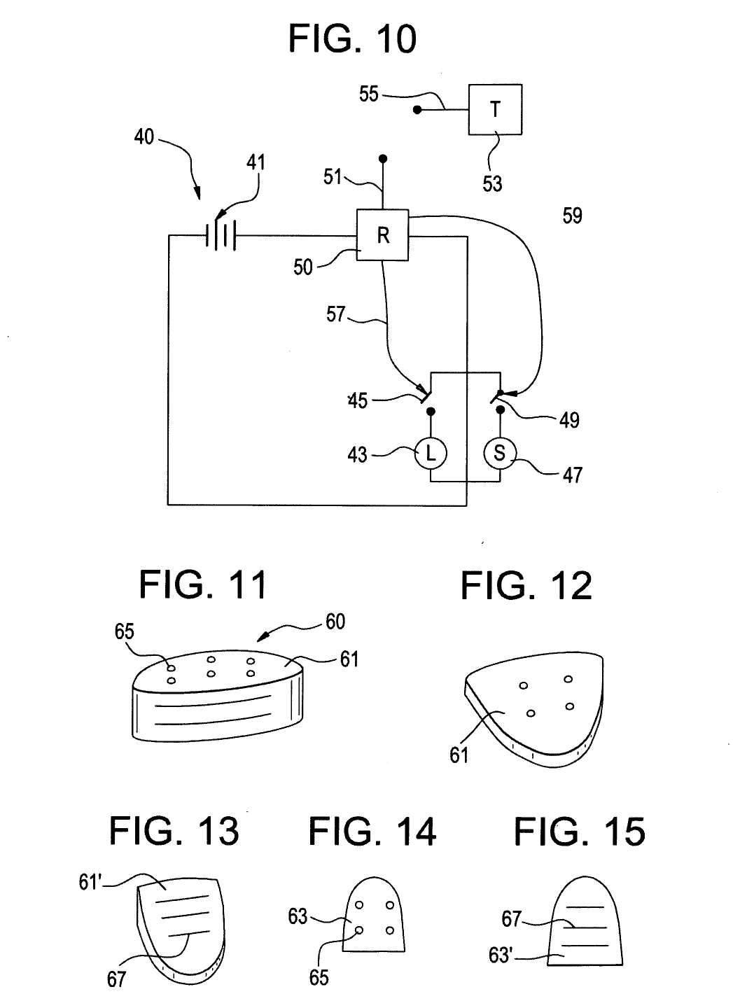

With reference to FIG. 10, a circuit to facilitate activation of the indicators is shown. This circuit is applicable to either the indicators 37, 39 mounted on the palatal vault 11 or those mounted on the tubular indicator 30. As shown in FIG. 10, the circuit 40 includes a battery 41, a light indicator 43 associated with an on-off switch 45, and a sound indicator 47 associated with an on-off switch 49.

With further reference to FIG. 10, the circuit 40 also includes a receiver/controller 50 including an antenna 51 to allow wireless communication with the transmitter 53 via its antenna 55. The antennas may be located within transmitter and receiver housings or may extend outwardly therefrom. The conductor 57 allows the controller to send signals to the on-off switch 45 to control the position of on-off switch 45. Similarly, the conductor 59 allows the controller to send signals to the on-off switch 49 to control the position of on-off switch 49. The transmitter 53 may consist of a key FOB, a separate housing with an actuation button, or any other suitable wireless transmitter including one incorporated into a cellular telephone. The transmitter has its own battery power source.

With reference to FIGS. 11-15, a case is generally designated by the reference numeral 60 and includes a lid 61 and a body 63 (FIGS. 11, 12 and 14). As shown in FIGS. 11, 12 and 14, a plurality of LED lights are installed on the lid 61 and body 63 (FIG. 14). Alternatively, the lid 61 can be replaced with a lid 61′ that includes a plurality of LED light strips 67 (FIG. 13). Similarly, the body 63 can be replaced with a body 63′ (FIG. 15) having a plurality of LED strips. The circuit shown in FIG. 10 can be used to activate the lights shown in FIGS. 11-15. Additionally, the case 60 can also be provided with an audible indicator also actuated in the same manner as depicted in the circuit of FIG. 10.

Based upon the aspects of the present invention shown in FIGS. 7-15, the user of the inventive retainer 10 can store the retainer within a case 60 and the retainer and/or the case can include audible and visual indicators to allow them to be easily located so that they will not be lost. This is especially true with respect to those who are visually or hearing impaired.

As such, an invention has been disclosed in terms of preferred embodiments thereof which fulfill each and every one of the objects of the invention as set forth hereinabove, and provide a new and useful illuminated orthodontic retainer of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. In an orthodontic retainer including a maxillary palatal vault having an upper surface facing a user's palate and an undersurface facing a user's tongue, the improvement comprising illumination means comprising:
a) a source of light mounted on said vault and oriented to shine light toward a user's tongue when said retainer is received within said user's mouth;
b) a source of power connected to said source of light;
c) pattern means including an opening for causing light emanating from said source of light to be displayed in a pattern corresponding to a shape of said opening, said pattern means comprising a template removably mounted beneath said source of light so that light shines through said opening when said source of light is activated;
d) said pattern configured to shine on said tongue when said retainer is positioned in a user's mouth; and
e) an indicator to facilitate locating said retainer.

2. The retainer of claim 1, wherein said indicator is visual.

3. The retainer of claim 1, wherein said indicator is audible.

4. The retainer of claim 1, wherein said indicator is visual and audible.

5. The retainer of claim 1, wherein said indicator is actuated remotely.

6. The retainer of claim 5, wherein said indicator is in an electric circuit including a wireless transmitter/receiver.

7. The retainer of claim 1, wherein said indicator is mounted on said retainer.

8. The retainer of claim 1, wherein said indicator comprises a tubular body removably mounted on said retainer.

9. The retainer of claim 8, wherein said tubular body is removably mounted on a wire of said retainer.

10. The retainer of claim 7, wherein said indicator comprises an electric circuit mounted on said palatal vault.

11. The retainer of claim 1, further including a case for removably enclosing said retainer.

12. The retainer of claim 11, wherein said indicator is incorporated into said case.

13. The retainer of claim 12, wherein said indicator is visual and audible.

14. The retainer of claim 13, wherein said indicator is actuated remotely.

15. The retainer of claim 12, wherein said indicator comprises a plurality of LEDs.

16. The retainer of claim 15, wherein said LEDs are arranged as elongated lines.

17. In an orthodontic retainer including a maxillary palatal vault having an upper surface facing a user's palate and an undersurface facing a user's tongue, the improvement comprising illumination means comprising:
a) a source of light comprising at least one light emitting diode (LED) embedded in said vault and oriented to shine light toward a user's tongue when said retainer is received within said user's mouth;
b) a source of power connected to said source of light and embedded in said vault, and an on-off switch connected between said source of power and source of light;
c) pattern means including an opening for causing light emanating from said source of light to be displayed in a pattern corresponding to a shape of said opening, said pattern configured to shine on said tongue in substantially said desired shape when said retainer is positioned in a user's mouth; and
d) an indicator to facilitate locating said retainer.

18. The retainer of claim 17, wherein said indicator is visual and audible.

19. The retainer of claim 17, further including a case for removably enclosing said retainer.

20. The retainer of claim 19, wherein said indicator is chosen from the group consisting of a tubular body mounted on a wire of said retainer, a circuit mounted on said palatal vault, and an indicator mounted on said case.
